(19) United States
(12) Patent Application Publication
(10) Pub. No.: US 2026/0310123 A1
(43) Pub. Date: Oct. 8, 2026

(54) IMAGE FORMING SYSTEM, COLOR MEASUREMENT CONTROL METHOD, AND STORAGE MEDIUM

(71) Applicant: Konica Minolta, Inc., Tokyo (JP)

(72) Inventor: Tatsuya KITAGUCHI, Tokyo (JP)

(21) Appl. No.: 19/631,841

(22) Filed: Mar. 27, 2026

(30) Foreign Application Priority Data
Apr. 4, 2025 (JP) 2025-062203

(51) Int. Cl. G03G 15/00

(52) U.S. Cl. CPC G03G 15/5062; G03G 15/652; G03G 2215/00063; G03G 2215/00067; G03G 2215/00455; G03G 2215/00569; G03G 2215/00616; G03G 2215/00949

(57) ABSTRACT

An image forming system includes: an image former configured to form an image on continuous paper; a color measurement section configured to measure color of the image formed on the continuous paper by the image former; a conveyor configured to convey the continuous paper; and a hardware processor configured to control: a first operation of causing the conveyor to convey the continuous paper by a predetermined length in a conveyance direction and to rewind-convey the continuous paper by the predetermined length in a direction opposite to the conveyance direction; and a second operation of moving the color measurement section by a predetermined distance in a width direction orthogonal to the conveyance direction of the continuous paper. The hardware processor repeats the first operation and the second operation until color measurement of the image by the color measurement section is completed.

### CROSS-REFERENCE TO RELATED APPLICATIONS

The entire disclosure of Japanese Patent Application No. 2025-062203, filed on Apr. 4, 2025, is incorporated herein by reference in its entirety.

### BACKGROUND OF THE INVENTION

### Technical Field

The present disclosure relates to an image forming system, a color measurement control method, and a storage medium.

### Description of Related Art

Conventionally, an image forming apparatus includes a mechanism for ensuring color matching (color characteristics). Specifically, the image forming apparatus compares (i) a color measurement value obtained by measuring, with a colorimeter, the color of an image formed on a sheet with (ii) image data of the image, and corrects, based on the comparison result, a color conversion table used for image forming processing. For example, a method is known in which color matching is performed by performing color measurement for only one line with a fixed colorimeter while conveying a sheet.

In recent years, there has also been a demand for color matching based on color measurement for printed matter produced by a roll sheet (continuous paper) printing machine. For example, Japanese Unexamined Patent Application Publication No. 2022-170996 discloses a configuration for performing color matching by performing color measurement on an image printed by a roll sheet printing machine.

On the other hand, in a sheet-fed press, a test chart for color measurement is fed prior to starting a job, and the entire surface of the image on the sheet is read by a colorimeter (full-surface color measurement). For example, Japanese Unexamined Patent Application Publication No. 2022-74928 discloses a configuration for performing color measurement over the entire surface of a sheet by stopping conveyance of the sheet and reciprocating a colorimeter in the CD direction of the sheet while advancing the sheet by one line.

### SUMMARY OF THE INVENTION

However, in the configuration described in Japanese Unexamined Patent Application Publication No. 2022-170996, if the number of colors is increased in one-line color measurement to perform high-precision color measurement, the chart image becomes longer in proportion to the number of patches, resulting in increased paper waste.

In addition, when the configuration described in Japanese Unexamined Patent Application Publication No. 2022-74928 is applied to a roll sheet printing machine, it is extremely difficult to accurately stop and convey the paper web at each patch interval because the paper conveyance drive mechanism of the roll sheet printing machine is designed for long-distance conveyance. Accordingly, there is a problem that color measurement accuracy decreases. In addition, a method is conceivable in which a plurality of rows are simultaneously subjected to color measurement by a plurality of colorimeters; however, a configuration including a plurality of colorimeters is generally expensive.

An object of the present disclosure is to provide an image forming system, a color measurement control method, and a storage medium that enable highly accurate color measurement over an entire surface at low cost and with reduced waste, even in a printing machine for a continuous paper.

To achieve at least one of the above-mentioned objects, according to an aspect of the present invention, an image forming system comprises:
an image former configured to form an image on continuous paper;
a color measurement section configured to measure color of the image formed on the continuous paper by the image former;
a conveyor configured to convey the continuous paper; and
a hardware processor configured to control:
   a first operation of causing the conveyor to convey the continuous paper by a predetermined length in a conveyance direction and to rewind-convey the continuous paper by the predetermined length in a direction opposite to the conveyance direction; and
   a second operation of moving the color measurement section by a predetermined distance in a width direction orthogonal to the conveyance direction of the continuous paper, wherein
the hardware processor repeats the first operation and the second operation until color measurement of the image by the color measurement section is completed.

### BRIEF DESCRIPTION OF THE DRAWINGS

The advantages and features provided by one or more embodiments of the invention will become more fully understood from the detailed description set forth below and the appended drawings, which are provided by way of illustration only and are not intended to define the limits of the present invention, wherein:

FIG. 1 is a diagram illustrating a schematic configuration of an image forming system according to the present embodiment;

FIG. 2 is a diagram illustrating a schematic configuration of the image forming apparatus;

FIG. 3 is a functional block diagram illustrating a control structure of the image forming apparatus and the image reading device;

FIG. 4 is a flowchart illustrating an example of control of the image forming system according to the present embodiment;

FIG. 5 is a diagram illustrating an example of reading all patches in a plurality of columns and a plurality of rows of a color measurement chart image printed on a continuous paper;

FIG. 6 is a diagram illustrating an example of a state in which a sensing section detects a trigger patch formed on a continuous paper conveyed in a conveyance direction (forward direction);

FIG. 7 is a diagram illustrating another example of reading all patches in a plurality of columns and a plurality of rows of a color measurement chart image printed on a continuous paper;

FIG. 8 is a diagram illustrating an example in which a sensing section detects a trigger patch formed on a continuous paper conveyed in a direction opposite to a conveyance direction;

FIG. 9 is a diagram illustrating an example in which a first sensing section detects a first trigger patch formed on a continuous paper conveyed in a conveyance direction (forward direction); and

FIG. 10 is a diagram illustrating an example in which a second sensing section detects a second trigger patch formed on a continuous paper conveyed in a direction opposite to the conveyance direction.

### DETAILED DESCRIPTION

Hereinafter, one or more embodiments of the present invention will be described with reference to the drawings. However, the scope of the invention is not limited to the disclosed embodiments.

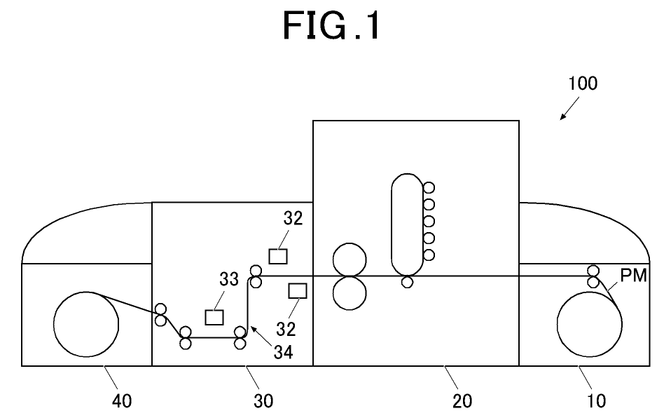

An image forming system 100 according to the present embodiment is a system that forms an image on a sheet. As shown in FIG. 1, the image forming system 100 includes a sheet feed device 10, an image forming apparatus 20, an image reading device 30, and a winding device 40. In the present embodiment, a configuration is described by way of example in which continuous paper PM, such as roll sheet or a continuous form, is used as a sheet.

The sheet feed device 10 accommodates a continuous paper PM and feeds the continuous paper PM to the image forming apparatus 20. In the housing of the sheet feed device 10, a roll-shaped continuous paper PM is wound around a support shaft and rotatably held.

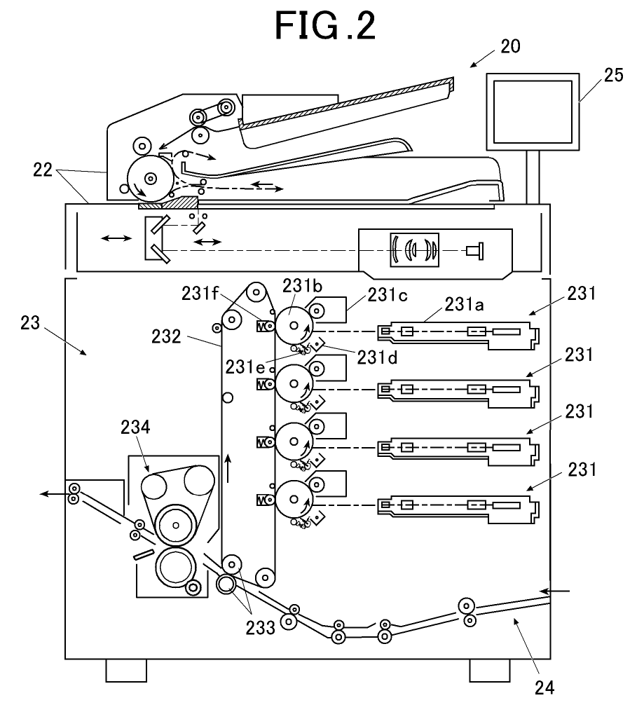

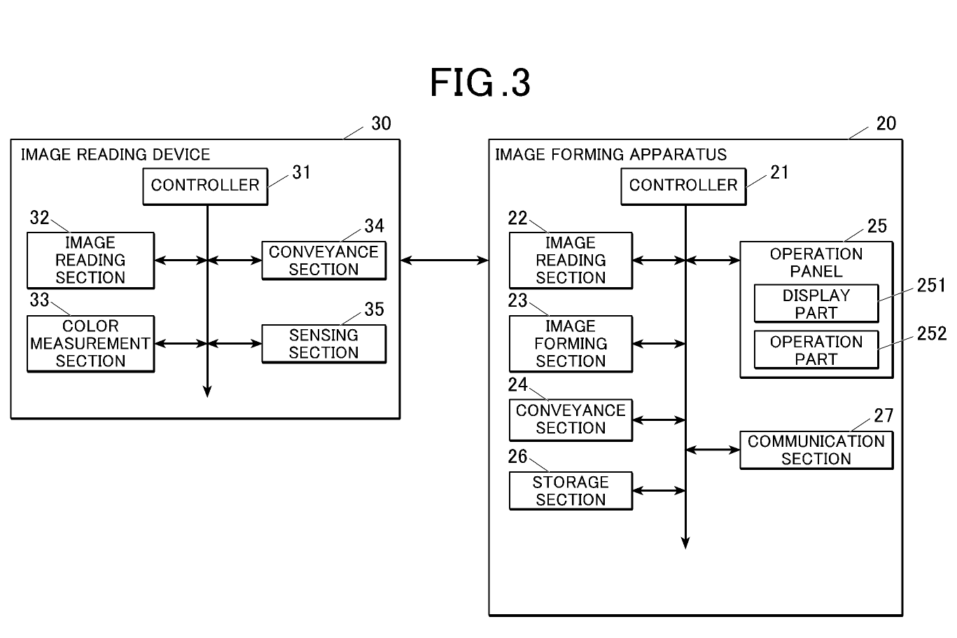

The image forming apparatus 20 forms an image on the continuous paper PM fed from the sheet feed device 10. As illustrated in FIGS. 2 and 3, the image forming apparatus 20 includes a controller 21, an image reading section 22, an image forming section 23 (image former), a conveyance section 24 (conveyor), an operation panel 25, a storage section 26, and a communication section 27.

The controller 21 includes a CPU, RAM, ROM, and the like. First, in response to a signal input from the operation part 252 or the communication section 27, the CPU reads various processing programs stored in the ROM and loads the various processing programs into the RAM. Next, the CPU comprehensively controls the operation of the image forming apparatus 20 in cooperation with the various programs loaded into the RAM.

First, the image reading section 22 scans and exposes an image of a document placed on a document plate or an automatic document feeder (ADF) using an optical system of a scanning exposure device. Next, the image reading section 22 reads reflected light during scanning exposure using a line image sensor to obtain an image signal. The image signal is subjected to processing such as A/D conversion, shading correction, and compression, and is then input to the controller 21 as image data. Note that the image data input to the controller 21 is not limited to image data read by the image reading section 22. The image data input to the controller 21 may be, for example, data received from an external device (not shown) via the communication section 27.

The image forming section 23 forms, on a continuous paper PM, a four-color image of C, M, Y, and K in accordance with the four color pixel values of each pixel of the image-processed original image.

The image forming section 23 includes four writing sections 231, an intermediate transfer belt 232, a secondary transfer roller 233, a fixing section 234, and the like.

The four writing sections 231 are arranged in series (tandem) along the belt surface of the intermediate transfer belt 232 and form images of respective colors C, M, Y, and K. Each writing section 231 has the same configuration except that the color of the image to be formed differs. Each writing section 231 includes an exposure section 231a, a photoreceptor 231b, a developing section 231c, a charging section 231d, a cleaning section 231e, and a primary transfer roller 231f.

When forming an image, each writing section 231 first charges the photoreceptor 231b using the charging section 231d. Next, each writing section 231 scans the photoreceptor 231b with a light beam emitted from the exposure section 231a based on image data (original image), thereby forming an electrostatic latent image on the photoreceptor 231b. Next, each writing section 231 causes the developing section 231c to supply toner to, and develop, the electrostatic latent image formed on the photoreceptor 231b. As a result, an image (a single-color toner image) is formed on the photoreceptor 231b.

Next, each writing section 231 causes its primary transfer roller 231f to sequentially superimpose and primarily transfer the image formed on its photoreceptor 231b onto the intermediate transfer belt 232. As a result, an image composed of the respective colors (a color toner image) is formed on the intermediate transfer belt 232. Next, each writing section 231 causes the cleaning section 231e to remove toner remaining on the photoreceptor 231b.

The sheet feed device 10 feeds the continuous paper PM in synchronization with the timing at which the image on the rotating intermediate transfer belt 232 reaches the position of the secondary transfer roller 233. The secondary transfer roller 233 includes a pair of rollers. One of the rollers is in pressure contact with the intermediate transfer belt 232. The other roller constitutes one of a plurality of rollers around which the intermediate transfer belt 232 is wound. The secondary transfer roller 233 secondarily transfers, onto a continuous paper PM, a toner image that has been primarily transferred onto an outer peripheral surface of the intermediate transfer belt 232. When an image is secondarily transferred onto the continuous paper PM by pressure contact of the secondary transfer roller 233, the fixing section 234 performs a fixing process, and the continuous paper PM is conveyed to the image reading device 30. The fixing process fixes an image to the continuous paper PM by heating and applying pressure to the continuous paper PM.

The conveyance section 24 is a conveyance mechanism for a continuous paper PM and includes a plurality of rollers. The conveyance section 24 first conveys the continuous paper PM fed from the sheet feed device 10 to the image forming section 23. Next, the conveyance section 24 conveys the continuous paper PM that has passed through the image forming section 23 to the image reading device 30.

The operation panel 25 includes a display part 251 configured to display various types of information to a user, and an operation part 252 configured to receive an operation input from the user.

The display part 251 includes a color liquid crystal display or the like. The display part 251 displays an operation screen and the like in accordance with a display control signal input from the controller 21. The operation screen includes, for example, various setting screens, various buttons, and operation statuses of respective functions.

The operation part 252 includes a touch screen provided on the screen of the display part 251, and various hard keys disposed around the screen of the display part 251. When a button displayed on the screen is pressed with a finger, a touch pen, or the like, the operation part 252 first detects X-Y coordinates of a point of application of the pressing force as voltage values. Next, the operation part 252 outputs, to the controller 21, an operation signal associated with the detected position. The touch screen is not limited to a pressure-sensitive type, and may be, for example, a capacitive type, an optical type, or the like. When a hard key is pressed, the operation part 252 outputs, to the controller 21, an operation signal associated with the pressed key. A user can operate the operation part 252 to perform settings related to image formation, issue a sheet conveyance instruction, perform a stop operation of the apparatus, and the like. The settings related to image formation include, for example, an image-quality setting, a magnification setting, an application setting, an output setting, and a sheet setting.

The storage section 26 is a non-volatile storage means including a hard disk drive (HDD), a solid-state drive (SSD), or the like. The storage section 26 stores various programs, various setting data, and the like so as to be readable and writable by the controller 21.

The communication section 27 includes a communication IC, a communication connector, and the like, and serves as an interface for connecting the image forming apparatus 2 to a communication network. Under the control of the controller 21, the communication section 27 transmits and receives various types of information to and from an external device connected to a communication network using a predetermined communication protocol. The communication section 27 can also input and output various types of information via USB.

The image reading device 30 is connected downstream of the image forming apparatus 20, and optically reads an image formed on continuous paper PM by the image forming apparatus 20. As illustrated in FIGS. 1 and 3, the image reading device 30 includes a controller 31, an image reading section 32, a color measurement section 33, a conveyance section 34, and a sensing section 35 (sensor).

The controller 31 includes a CPU, a ROM, a RAM, and the like, and collectively controls operations of the respective sections of the image reading device 30.

The image reading section 32 scans both sides of the continuous paper PM on which an image has been formed by the image forming section 23, thereby optically reading the images on both sides of the continuous paper PM. The read image obtained by the image reading section 32 is output to the controller 21 of the image forming apparatus 20 via the controller 31.

The color measurement section 33 is disposed downstream of the image reading section 32 in the conveyance direction of the continuous paper PM, and performs color measurement on an image formed on the continuous paper PM by the image forming section 23. The color measurement section 33 spectroscopically measures a color of each color patch of a patch image formed on the continuous paper PM by the image forming section 23, and acquires color measurement data. A color measurement result obtained by the color measurement section 33 is output to the controller 21 of the image forming apparatus 20 via the controller 31.

The color measurement section 33 is configured to be movable in a width direction (CD direction) orthogonal to the conveyance direction of the continuous paper PM.

The conveyance section 34 is a conveyance mechanism for the continuous paper PM and includes a plurality of rollers. The conveyance section 34 conveys the continuous paper PM conveyed from the image forming apparatus 20 to the winding device 40. Thus, image reading by the image reading section 32 and color measurement by the color measurement section 33 can be performed.

The sensing section 35 is an optical sensor configured to detect a trigger patch formed on the continuous paper PM. The trigger patch is a patch indicating timing to start color measurement by the color measurement section 33. A detection result obtained by the sensing section 35 (i.e., detection of the trigger patch) is output to the controller 31. When the detection result from the sensing section 35 is input, the controller 31 generates a color measurement trigger signal. Then, the controller 31 causes the color measurement section 33 to start color measurement at a timing when a predetermined time has elapsed from generation of the color measurement trigger signal.

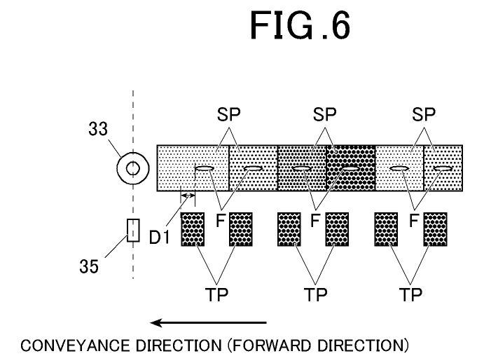

The sensing section 35 is provided outside the color measurement section 33 in the width direction of the continuous paper PM (on the lower side in FIG. 6) (see FIG. 6). The sensing section 35 is provided at substantially the same position as the color measurement section 33 in the conveyance direction of the continuous paper PM (see FIG. 6).

The winding device 40 winds the continuous paper PM fed out by the image reading device 30 into a roll. In the housing of the winding device 40, the continuous paper PM is wound around a support shaft and held as a roll.

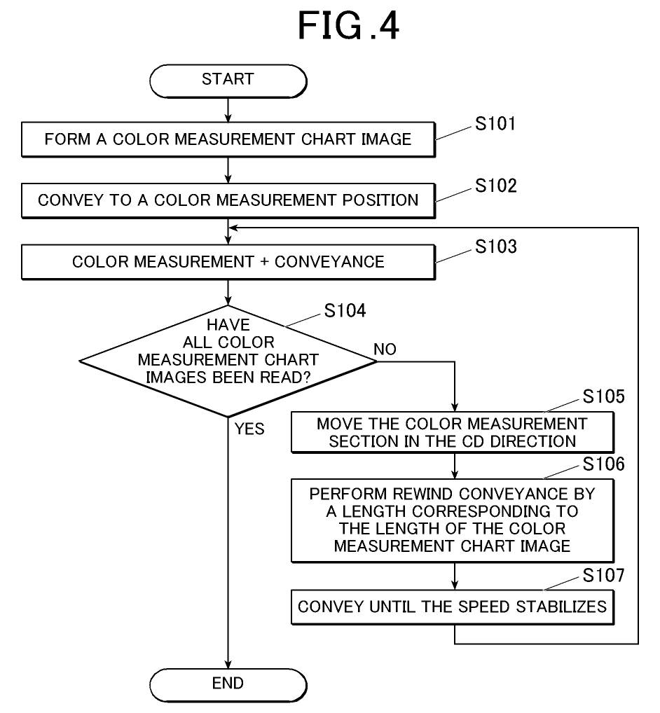

Next, control of the image forming system 1 according to the present embodiment will be described with reference to the flowchart of FIG. 4. The control in FIG. 4 is control for causing the color measurement section 33 to read all patches in a color measurement chart image printed on the continuous paper PM, across a plurality of columns and a plurality of rows. Note that, in the example illustrated in FIG. 4, a case will be described in which the controller 21 of the image forming apparatus 20 plays a central role (i.e., serves as a command center) and instructs the controller of each apparatus to execute processing; however, the present disclosure is not limited thereto. For example, the controller 31 of the image reading device 30 (or a controller (not shown) provided separately from the respective apparatuses) may be configured to play a central role. Further, the controllers 21 and 31 of the respective apparatuses (the image forming apparatus 20 and the image reading device 30) constituting the image forming system 100 may cooperate with each other to execute the processing.

First, the controller 21 causes the image forming section 23 to form a color measurement chart image on the continuous paper PM (step S101).

Next, the controller 21 conveys the continuous paper PM on which the color measurement chart image is formed to a color measurement position (step S102). Specifically, the controller 21 conveys the continuous paper PM such that the color measurement chart image formed on the continuous paper PM reaches a color measurement position of the color measurement section 33. Conveyance of the continuous paper PM is performed through cooperation of the sheet feed device 10, the conveyance section 24, the conveyance section 34, and the winding device 40.

Next, the controller 21 causes the color measurement section 33 to measure the color of the color measurement chart image formed on the continuous paper PM while conveying the continuous paper PM in the conveyance direction by a length of the color measurement chart image (step S103). In the present embodiment, the color measurement section 33 performs color measurement of an image only while the continuous paper PM is being conveyed in the conveyance direction.

Next, the controller 21 determines whether the color measurement section 33 has read all of the color measurement chart images (step S104).

If the controller 21 determines that the color measurement section 33 has read all of the color measurement chart images (step S104: YES), the process ends.

If the controller 21 determines that the color measurement section 33 has not read all of the color measurement chart images (step S104: NO), the process proceeds to the next step S105.

In step S105, the controller 21 moves the color measurement section 33 by a predetermined distance in a width direction (CD direction) orthogonal to the conveyance direction of the continuous paper PM. The predetermined distance is a distance corresponding to the size of a color measurement patch formed on the continuous paper PM (one row).

Next, the controller 21 causes the continuous paper PM to be rewind-conveyed in a direction opposite to the conveyance direction by a length of the color measurement chart image (step S106).

Next, the controller 21 conveys the continuous paper PM until the conveyance speed stabilizes (step S107). Specifically, the controller 21 conveys the continuous paper PM until the conveyance speed reaches a predetermined speed. Here, the predetermined speed is a speed that can be regarded as enabling appropriate color measurement. Thereafter, the process proceeds to step S103, and the processing is repeated until color measurement for all rows is completed.

That is, the color measurement section 33 starts color measurement of the image after the conveyance speed at which the conveyance section conveys the continuous paper PM reaches a predetermined speed.

Accordingly, all patches across a plurality of columns and a plurality of rows of the color measurement chart image printed on the continuous paper PM can be read. Note that steps S105 and S106 may be performed in any order, and the processing may be performed in the order of step S106 → step S105.

As described above, the controller 21 controls a first operation in which the conveyance section (e.g., the conveyance section 34) conveys the continuous paper PM by a predetermined length in a conveyance direction and performs rewind conveyance of the continuous paper PM by the predetermined length in a direction opposite to the conveyance direction. The predetermined length is the length of the color measurement chart image.

In addition, the controller 21 controls a second operation of moving the color measurement section 33 by a predetermined distance in a width direction (CD direction) orthogonal to the conveyance direction of the continuous paper PM. The predetermined distance is a distance (for one line) corresponding to a size of a color measurement patch formed on the continuous paper PM.

Then, the controller 21 repeats the first operation and the second operation until color measurement of the image by the color measurement section 33 is completed.

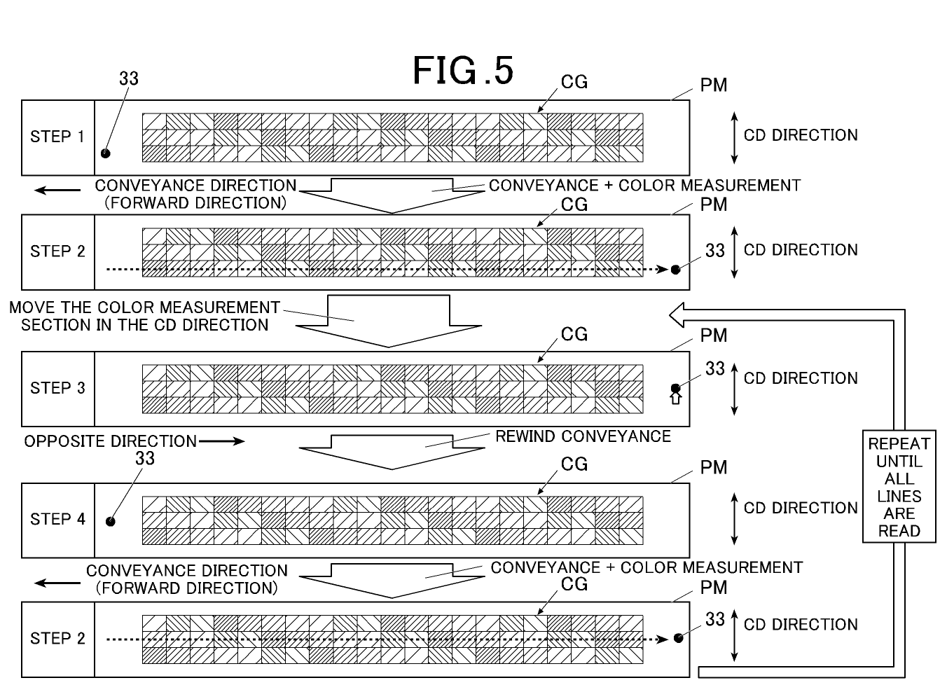

FIG. 5 is a diagram illustrating an example of reading all patches in a plurality of columns and a plurality of rows of a color measurement chart image CG printed on a continuous paper PM.

First, the color measurement section 33 is moved to an end portion of the color measurement chart image CG in the CD direction (the width direction of the continuous paper PM) (Step 1). Thus, the travel distance of the color measurement section 33 can be minimized. In Step 1 of FIG. 5, the color measurement section 33 is disposed at an end portion on the near side (a lower side in the drawing), but may instead be disposed at an end portion on the far side (an upper side in the drawing).

That is, an initial position of the color measurement section 33 is at either of widthwise end portions of a color measurement chart image CG formed on a continuous paper PM.

Next, while continuous paper PM is conveyed in a conveyance direction (a forward direction), the color measurement section 33 performs color measurement for one line (Step 2).

Next, the color measurement section 33 is moved in the CD direction by an amount corresponding to one patch (i.e., one row) (Step 3).

Next, the continuous paper PM is conveyed in a direction opposite to the conveyance direction (rewind conveyance) (Step 4).

Next, conveyance of the continuous paper PM in the conveyance direction (forward direction) is started, and conveyance of the continuous paper PM is continued until the conveyance speed stabilizes. Thereafter, the process proceeds to Step 2, and the processing is repeated until the color measurement of all rows is completed. Accordingly, all patches across a plurality of columns and a plurality of rows in the color measurement chart image CG printed on the continuous paper PM can be read. Steps 3 and 4 may be performed in any order; for example, the processing may be performed in the order of Step 4 followed by Step 3.

The timing at which the color measurement section 33 starts color measurement (i.e., the timing at which the color measurement section 33 reaches the color measurement position) is the timing at which a predetermined time has elapsed after the trigger patch formed on the continuous paper PM is detected by the sensing section 35. That is, the color measurement section 33 starts color measurement of the image after a predetermined time has elapsed since the trigger patch formed on the continuous paper PM is detected by the sensing section 35.

FIG. 6 is a diagram illustrating an example of how the sensing section 35 detects the trigger patch TP formed on the continuous paper PM being conveyed in the conveyance direction (forward direction).

As shown in FIG. 6, a trigger patch TP is provided for each color measurement patch SP in a one-to-one correspondence. The trigger patch TP is provided outward, in the width direction of the continuous paper PM, from the color measurement patch SP (downward in FIG. 6). In addition, each trigger patch TP is provided downstream, in the conveyance direction, of a reading position F of the corresponding color measurement patch SP. In the example shown in FIG. 6, the sensing section 35 is provided at substantially the same position as the color measurement section 33 in the conveyance direction of the continuous paper PM; however, the present disclosure is not limited thereto. For example, the sensing section 35 may be provided upstream of the color measurement section 33 in the conveyance direction of the continuous paper PM. That is, the configuration may be such that detection of the trigger patch TP by the sensing section 35 is performed before color measurement of the color measurement patch SP by the color measurement section 33.

As described above, the image forming system 100 according to the present embodiment includes a controller 21 (a hardware processor) configured to control a first operation and a second operation. In the first operation, a conveyance section (e.g., the conveyance section 34) conveys the continuous paper PM by a predetermined length in the conveyance direction and rewind-conveys the continuous paper PM by a predetermined length in a direction opposite to the conveyance direction. In the second operation, the color measurement section 33 is moved by a predetermined distance in a width direction orthogonal to the conveyance direction of the continuous paper PM. The controller 21 repeats the first operation and the second operation until the color measurement of the image by the color measurement section 33 is completed.

Accordingly, even for a continuous paper printing machine, it is possible to perform color measurement over an entire area using a single colorimeter, without increasing the length of a chart image, and without stopping at each patch interval. Accordingly, color measurement can be performed over the entire surface with high accuracy at low cost and with little waste.

The color measurement section 33 measures the color of an image only while the continuous paper PM is being conveyed in the conveyance direction.

Accordingly, color measurement can be performed over the entire surface using existing conveyance control. Accordingly, color measurement can be performed over the entire surface of the continuous paper PM with high accuracy at low cost.

Additionally, the predetermined distance is a distance corresponding to the size of a color measurement patch formed on the continuous paper PM.

Accordingly, a plurality of columns of color measurement patches formed on the continuous paper PM can be measured by a single colorimeter. Accordingly, color measurement can be performed over the entire surface of the continuous paper PM with high accuracy at low cost and with little waste.

In addition, the color measurement section 33 starts color measurement of an image after the conveyance speed of the continuous paper PM conveyed by the conveyance section reaches a predetermined speed.

Accordingly, the conveyance speed during color measurement by the color measurement section 33 can be stabilized. Thus, the color measurement accuracy for the continuous paper PM can be ensured.

In addition, the color measurement section 33 has an initial position at one of widthwise end portions of a color measurement chart image formed on the continuous paper PM.

Thus, the travel distance of the color measurement section 33 can be minimized. Thus, productivity can be improved by enabling the color measurement section 33 to perform color measurement more efficiently.

There is provided a sensing section 35 configured to detect a trigger patch indicating a timing at which the color measurement section 33 starts color measurement. The color measurement section 33 starts color measurement of the image after a predetermined time has elapsed since the sensing section 35 detects a trigger patch formed on the continuous paper PM.

Thus, the timing to start color measurement can be determined accurately. Thus, the color measurement accuracy of the continuous paper PM can be sufficiently ensured.

Although the present disclosure has been described in detail with reference to the embodiments, the present disclosure is not limited to the embodiments described above, and can be modified without departing from the spirit and scope of the present disclosure.

For example, in the above-described embodiment, a configuration in which color measurement is performed only when the continuous paper PM is conveyed in the forward direction has been described by way of example; however, the present disclosure is not limited thereto. That is, color measurement may be performed not only during conveyance in the forward direction but also during conveyance in the opposite direction.

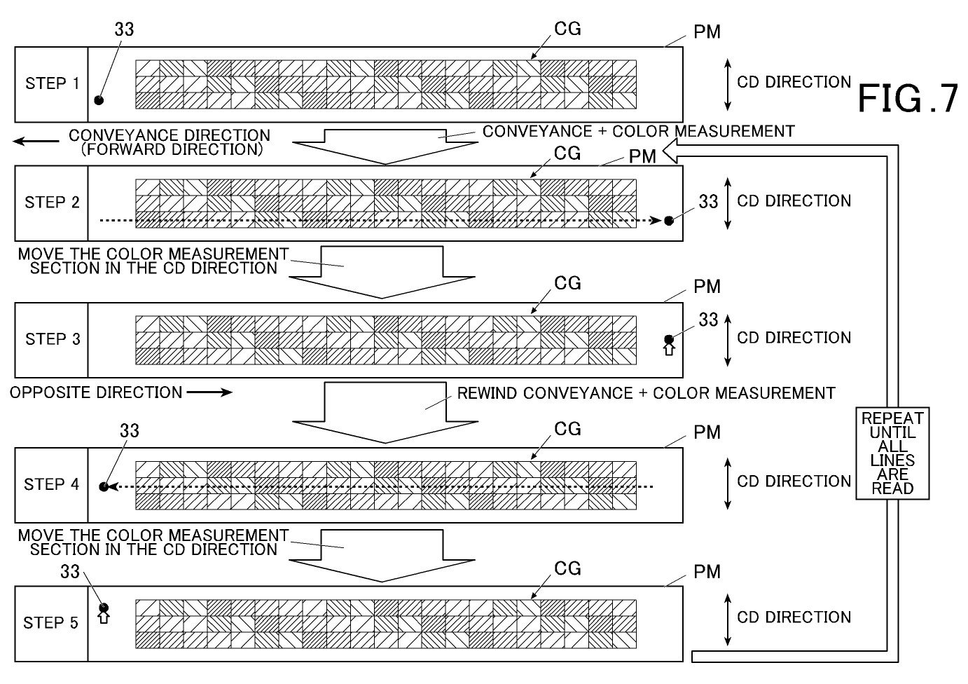

FIG. 7 is a diagram illustrating another example of how all patches arranged in multiple columns and multiple rows of a color measurement chart image CG printed on the continuous paper PM are read.

First, the color measurement section 33 is moved to an end portion of the color measurement chart image CG in the CD direction (Step 1). Thus, the travel distance of the color measurement section 33 can be minimized. In Step 1 of FIG. 7, the color measurement section 33 is disposed at an end portion on the near side (the lower side in the drawing), but may alternatively be disposed at an end portion on the far side (the upper side in the drawing).

Next, while the continuous paper PM is conveyed in the conveyance direction (forward direction), the color measurement section 33 performs color measurement for one line (Step 2).

Next, the color measurement section 33 is moved in the CD direction by one patch (one row) (Step 3).

Next, conveyance of the continuous paper PM is started in a direction opposite to the conveyance direction, and the continuous paper PM is continuously conveyed until the speed stabilizes. Then, while the continuous paper PM is conveyed in a direction opposite to the conveyance direction (rewind conveyance), the color measurement section 33 performs color measurement for one line (Step 4).

Next, the color measurement section 33 is moved in the CD direction by one patch (one row) (Step 5). Then, conveyance of the continuous paper PM is started in the conveyance direction (forward direction), and the continuous paper PM is continuously conveyed until the speed stabilizes. Thereafter, the process proceeds to Step 2, and the process is repeated until color measurement for all rows is completed. Accordingly, all patches in a plurality of columns and a plurality of rows of the color measurement chart image CG printed on the continuous paper PM can be read.

As described above, the color measurement section 33 performs color measurement of an image both when the continuous paper PM is conveyed in the conveyance direction and when the continuous paper PM is conveyed in a direction opposite to the conveyance direction.

Accordingly, by effectively using bidirectional conveyance, the color measurement section 33 can perform color measurement efficiently. Thus, productivity in color measurement can be improved.

In addition, the color measurement section 33 may change a predetermined time (a time from detection of the trigger patch to start of color measurement) between when the continuous paper PM is conveyed in the conveyance direction and when the continuous paper PM is conveyed in a direction opposite to the conveyance direction.

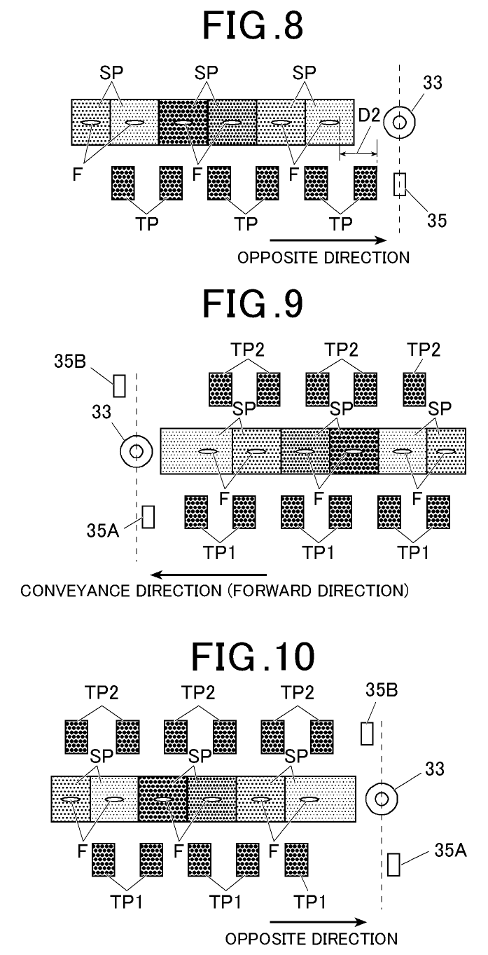

FIG. 8 is a diagram illustrating an example of how the sensing section 35 detects a trigger patch TP formed on a continuous paper PM conveyed in a direction opposite to the conveyance direction.

A distance D1 (see FIG. 6) between the trigger patch TP and the reading position F during conveyance in a conveyance direction is shorter than a distance D2 (see FIG. 8) between the trigger patch TP and the reading position F during conveyance in the opposite direction. That is, the predetermined time during conveyance in the conveyance direction is shorter than the predetermined time during conveyance in the opposite direction. Note that distances D1 and D2 need not be different from each other and may be equal to each other.

As described above, the color measurement section 33 changes a predetermined time depending on whether the continuous paper PM is conveyed in the conveyance direction or in a direction opposite to the conveyance direction.

Thus, regardless of the conveyance direction, a single sensing section 35 can accurately detect the timing at which the color measurement section 33 starts color measurement. Thus, color measurement accuracy of the continuous paper PM can be sufficiently ensured.

In the above-described embodiment, a configuration in which one sensing section 35 detects a trigger patch TP is described by way of example; however, the present disclosure is not limited thereto. For example, the sensing section of the present disclosure may be configured to include a first sensing section 35A and a second sensing section 35B.

In this case, the first sensing section 35A detects a first trigger patch TP1 indicating a timing at which the color measurement section 33 starts color measurement when the continuous paper PM is conveyed in the conveyance direction. The second sensing section 35B detects a second trigger patch TP2 indicating a timing to start color measurement by the color measurement section 33 when the continuous paper PM is conveyed in a direction opposite to the conveyance direction.

FIG. 9 is a diagram illustrating an example in which the first sensing section 35A detects a first trigger patch TP1 formed on a continuous paper PM conveyed in a conveyance direction (forward direction).

As shown in FIG. 9, the first trigger patches TP1 are provided to correspond on a one-to-one basis with the respective color measurement patches SP. The first trigger patch TP1 is provided outside the color measurement patch SP in a width direction of the continuous paper PM (on a lower side in FIGS. 9 and 10). In addition, each first trigger patch TP1 is provided downstream in the conveyance direction from a reading position F of a corresponding color measurement patch SP. Accordingly, during forward conveyance, the first trigger patch TP1 can be detected before the color measurement patch SP is read.

FIG. 10 illustrates an example in which the second sensing section 35B detects a second trigger patch TP2 formed on a continuous paper PM conveyed in a direction opposite to the conveyance direction.

As shown in FIG. 10, the second trigger patches TP2 are provided in one-to-one correspondence with the color measurement patches SP. The second trigger patch TP2 is provided outside the color measurement patch SP in a width direction of the continuous paper PM (on an upper side in FIGS. 9 and 10). In addition, each second trigger patch TP2 is provided upstream, in the conveyance direction, of a reading position F of a corresponding color measurement patch SP (i.e., downstream in the conveyance direction during conveyance in the opposite direction). Accordingly, during conveyance in the opposite direction, the second trigger patch TP2 can be detected before the color measurement patch SP is read.

As described above, the sensing section 35 includes a first sensing section 35A and a second sensing section 35B. The first sensing section 35A detects a first trigger patch TP1 indicating a timing to start color measurement by the color measurement section 33 when the continuous paper PM is conveyed in the conveyance direction. The second sensing section 35B detects a second trigger patch TP2 indicating a timing to start color measurement by the color measurement section 33 when the continuous paper PM is conveyed in a direction opposite to the conveyance direction.

Accordingly, regardless of the conveyance direction, the timing at which color measurement is started by the color measurement section 33 can be accurately detected. Thus, color measurement accuracy for the continuous paper PM can be sufficiently ensured.

In addition, in the above-described embodiment, a configuration is described by way of example in which continuous paper PM is conveyed by the entirety of the image forming system 1 (sheet feed device 10, conveyance section 24, conveyance section 34, and winding device 40); however, the present disclosure is not limited thereto. For example, a sheet buffer may be provided between the image forming apparatus 20 and the image reading device 30 or between the image reading device 30 and the winding device 40, and control may be performed such that only the conveyance section 34 of the image reading device 30 conveys the continuous paper PM. The sheet buffer is, for example, a path that allows a sheet length corresponding to a color measurement chart image to become slack.

In addition, in the above-described embodiment, color measurement of the image is started after the conveyance speed of continuous paper PM conveyed by a conveyance section (e.g., conveyance section 34) reaches a predetermined speed; however, the present disclosure is not limited thereto. For example, color measurement of the image may be started after continuous paper PM has been conveyed by the conveyance section over a preset distance or for a preset time period. Here, the preset distance or time is a distance or time over which it can be regarded that the conveyance speed is stable and that color measurement can be appropriately performed.

As described above, the color measurement section 33 starts color measurement of an image after the continuous paper PM has been conveyed by the conveyance section over a preset distance or for a preset time period.

Thus, the conveyance speed during color measurement by color measurement section 33 can be stabilized. Thus, color measurement accuracy for continuous paper PM can be ensured.

According to the present embodiment, even in a printing machine for a continuous paper, it is possible to perform color measurement over an entire surface with high accuracy at low cost and with little spoilage.

In addition, the detailed configuration of each apparatus constituting the image forming system and the detailed operation of each apparatus may be modified as appropriate without departing from the spirit of the present disclosure.

Although embodiments of the present invention have been described and illustrated in detail, the disclosed embodiments are set forth for purposes of illustration and example only, and not by way of limitation. The scope of the present invention is to be construed in accordance with the appended claims.

What is claimed is:

1. An image forming system comprising:
an image former configured to form an image on continuous paper;
a color measurement section configured to measure color of the image formed on the continuous paper by the image former;
a conveyor configured to convey the continuous paper; and
a hardware processor configured to control:
a first operation of causing the conveyor to convey the continuous paper by a predetermined length in a conveyance direction and to rewind-convey the continuous paper by the predetermined length in a direction opposite to the conveyance direction; and
a second operation of moving the color measurement section by a predetermined distance in a width direction orthogonal to the conveyance direction of the continuous paper, wherein
the hardware processor repeats the first operation and the second operation until color measurement of the image by the color measurement section is completed.

2. The image forming system according to claim 1, wherein the color measurement section measures the color of the image only when the continuous paper is conveyed in the conveyance direction.

3. The image forming system according to claim 1, wherein the color measurement section measures the color of the image both when the continuous paper is conveyed in the conveyance direction and when the continuous paper is conveyed in the direction opposite to the conveyance direction.

4. The image forming system according to claim 1, wherein the predetermined distance is a distance corresponding to a size of a color measurement patch formed on the continuous paper.

5. The image forming system according to claim 1, wherein the color measurement section starts the color measurement of the image after a conveyance speed at which the conveyor conveys the continuous paper reaches a predetermined speed.

6. The image forming system according to claim 1, wherein the color measurement section starts the color measurement of the image after the continuous paper is conveyed by the conveyor over a preset distance or for a preset time.

7. The image forming system according to claim 1, wherein an initial position of the color measurement section is at one of two end portions in the width direction of a color measurement chart image formed on the continuous paper.

8. The image forming system according to claim 1, further comprising a sensor configured to detect a trigger patch indicating a timing at which the color measurement by the color measurement section is started, wherein
the color measurement section starts the color measurement of the image after a predetermined time has elapsed since the trigger patch formed on the continuous paper is detected by the sensor.

9. The image forming system according to claim 8, wherein the sensor includes:
a first sensor configured to detect a first trigger patch indicating a timing to start the color measurement by the color measurement section when the continuous paper is conveyed in the conveyance direction; and
a second sensor configured to detect a second trigger patch indicating a timing to start the color measurement by the color measurement section when the continuous paper is conveyed in the direction opposite to the conveyance direction.

10. The image forming system according to claim 8, wherein the color measurement section changes the predetermined time depending on whether the continuous paper is conveyed in the conveyance direction or in the direction opposite to the conveyance direction.

11. A color measurement control method for an image forming system comprising an image former configured to form an image on continuous paper, a color measurement section configured to perform color measurement on the image formed on the continuous paper by the image former, and a conveyor configured to convey the continuous paper, the color measurement control method comprising
controlling a first operation of causing the conveyor to convey the continuous paper by a predetermined length in a conveyance direction and to rewind-convey the continuous paper by the predetermined length in a direction opposite to the conveyance direction and a second operation of moving the color measurement section by a predetermined distance in a width direction orthogonal to the conveyance direction of the continuous paper, wherein
in the controlling, the first operation and the second operation are repeated until color measurement of the image by the color measurement section is completed.

12. A non-transitory computer-readable storage medium storing a program for a computer of an image forming system, the image forming system comprising an image former configured to form an image on continuous paper, a color measurement section configured to perform color measurement on the image formed on the continuous paper by the image former, and a conveyor configured to convey the continuous paper, the program causing the computer to perform
controlling a first operation of causing the conveyor to convey the continuous paper by a predetermined length in a conveyance direction and to rewind-convey the continuous paper by the predetermined length in a direction opposite to the conveyance direction and a second operation of moving the color measurement section by a predetermined distance in a width direction orthogonal to the conveyance direction of the continuous paper, wherein
in the controlling, the first operation and the second operation are repeated until color measurement of the image by the color measurement section is completed.
